(19) United States
(12) Patent Application Publication
(10) Pub. No.: US 2025/0293310 A1
(43) Pub. Date: Sep. 18, 2025

(54) ELECTRODE STACK AND METHOD FOR MANUFACTURING ELECTRODE STACK

(71) Applicant: TOYOTA JIDOSHA KABUSHIKI KAISHA, Toyota-shi (JP)

(72) Inventor: Shinya ISHIKAWA, Anjo-shi (JP)

(73) Assignee: TOYOTA JIDOSHA KABUSHIKI KAISHA, Toyota-shi (JP)

(21) Appl. No.: 19/006,389

(22) Filed: Dec. 31, 2024

(30) Foreign Application Priority Data
Mar. 14, 2024 (JP) 2024-040351

(51) Int. Cl. H01M 10/0585

(52) U.S. Cl. CPC H01M 10/0585

(57) ABSTRACT

The electrode stack of the present disclosure includes a first current collector layer, a first electrode active material layer, a solid electrolyte layer, a second electrode active material layer, and a second current collector layer in this order. The electrode stack of the present disclosure has a side surface cut in a direction that is not the stacking direction of the electrode stack. The method of the present disclosure for manufacturing an electrode stack includes the following steps: (a) providing a preliminary stack 20 in which a first current collector layer, a first electrode active material layer, a solid electrolyte layer, a second electrode active material layer, and a second current collector layer are stacked in this order; and (b) cutting the side of the preliminary stack in a direction that is not the stacking direction of the electrode stack.

### CROSS-REFERENCE TO RELATED APPLICATION

This application claims priority to Japanese Patent Application No. 2024-040351 filed on Mar. 14, 2024, incorporated herein by reference in its entirety.

### BACKGROUND

### 1. Technical Field

The present disclosure relates to electrode stacks and methods for manufacturing an electrode stack.

### 2. Description of Related Art

There is known a battery using an electrode stack as a power generation element of the battery. This electrode stack includes a first current collector layer, a first electrode active material layer, a solid electrolyte layer, a second electrode active material layer, and a second current collector layer in this order. There is a case where edges of the layers of the electrode stack are misaligned in a plane direction in the process of stacking the layers of the electrode stack. There is known a method that is performed in such a case. In this method, an edge of the electrode stack is cut in the stacking direction of the electrode stack in order to align the edges in the plane direction of the layers.

However, when an edge of the electrode stack is cut at a time with a circular saw blade etc., burrs may be formed on the current collector layers and/or the electrode active material layers, which may cause short-circuiting between different electrodes. It is desired to solve such an issue.

For example, Japanese Unexamined Patent Application Publication No. 2023-137711 (JP 2023-137711 A) discloses a secondary battery including an electrode stack in which a cathode current collector layer, a cathode active material layer, an electrolyte layer, an anode active material layer, and an anode current collector layer are stacked in this order. In this secondary battery, the cathode active material layer or the anode active material layer has an exposed surface portion at a stacking surface between the cathode current collector layer and the cathode active material layer or a stacking surface between the anode current collector layer and the anode active material layer.

### SUMMARY

This secondary battery has room for improvement in terms of reducing short-circuiting in an electrode stack in which edges in a plane direction are aligned.

It is an object of the present disclosure to provide an electrode stack that reduces short-circuiting and a method for manufacturing such an electrode stack.

The disclosers found that the above issue can be solved by the following means.

### First Aspect

An electrode stack includes
a first current collector layer, a first electrode active material layer, a solid electrolyte layer,
a second electrode active material layer, and a second current collector layer in this order.

The electrode stack includes a side surface cut in a direction that is not a stacking direction of the electrode stack.

### Second Aspect

In the electrode stack of the first aspect, the side surface may have a corrugated shape in a direction perpendicular to the stacking direction of the electrode stack.

### Third Aspect

A method for manufacturing the electrode stack of the first or second aspect includes:
(a) providing a preliminary stack in which a first current collector layer, a first electrode active material layer, a solid electrolyte layer, a second electrode active material layer, and a second current collector layer are stacked in this order; and
(b) cutting a side surface of the preliminary stack in a direction that is not a stacking direction of the electrode stack.

### Fourth Aspect

According to the method of the third aspect, in the step (b), the side surface of the preliminary stack may be cut with a cutting tool whose rotation axis is tilted by 30° or less with respect to the stacking direction of the electrode stack.

### Fifth Aspect

According to the method of the fourth aspect, the cutting tool may have a helix angle of 0°.

The present disclosure can provide an electrode stack that reduces short-circuiting and a method for manufacturing such an electrode stack.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating an example of a direction in which an electrode stack is cut in an electrode stack of the present disclosure having a side surface cut in a direction that is not the stacking direction of the electrode stack;

FIG. 2 is a schematic plan view illustrating an example of the shape of edges of the electrode stack of the present disclosure;

FIG. 3 is a schematic plan view illustrating a method of manufacturing an electrode stack of the present disclosure;

FIG. 4 is a cross-sectional image showing a cutting surface of an electrode stack of the present disclosure when a side surface of the electrode stack is cut with an end mill having a helix angle of 0°;

FIG. 5 is a schematic cross-sectional view illustrating a state in which the side surface of the electrode stack is cut in the stacking direction of the electrode stack; and

FIG. 6 is a cross-sectional image showing a cut surface of an electrode stack according to the prior art in a case where the electrode stack is cut using a circular saw blade.

### DETAILED DESCRIPTION OF EMBODIMENTS

Hereinafter, embodiments of the present disclosure will be described in detail with reference to the drawings. It should be noted that the present disclosure is not limited to the following embodiments, and various modifications can be made within the scope of the gist of the disclosure. In addition, the dimensional relationship in the drawings does not reflect the actual dimensional relationship.

### Electrode Stack

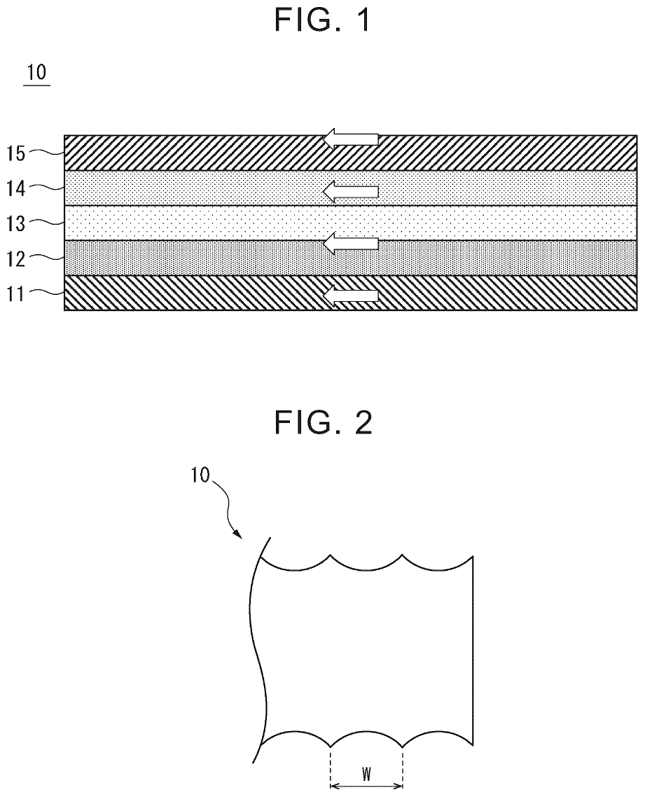

As illustrated in FIG. 1, the electrode stack 10 of the present disclosure includes a first current collector layer 11, a first electrode active material layer 12, a solid electrolyte layer 13, a second electrode active material layer 14, and a second current collector layer 15 in this order. As illustrated in FIG. 2, the electrode stack of the present disclosure has a side surface cut in a direction that is not the stacking direction of the electrode stack, in particular, a side surface cut in a direction perpendicular to the stacking direction of the electrode stack. Here, the direction of the cutting may be such that the deviation from the direction perpendicular to the stacking direction of the electrode stack (that is, the plane direction of the electrode stack) is 30° or less, 20° or less, 10° or less, 5° or less, 2° or less, 1° or less, or about 0°.

The inventors of the present disclosure considered that one of the causes of the occurrence of burrs in the current collector layer and/or the electrode active material layer by cutting the electrode stack in the stacking direction is that stress is applied to the cut surface of the electrode stack in the stacking direction of the electrode stack. In particular, in the case of cutting by using a cutting tool such as a circular saw blade or a metal sole, in addition to the stress in the stacking direction, a centrifugal force accompanying the rotation of the cutting tool is considered to be applied to the cross section of the electrode stack. In this case, it is considered that a portion to which a force is locally applied exists with respect to the cross section of the electrode stack, and as a result, burrs are formed on the current collector layer and/or the electrode active material layer, and thus short-circuiting occurs between the different electrodes.

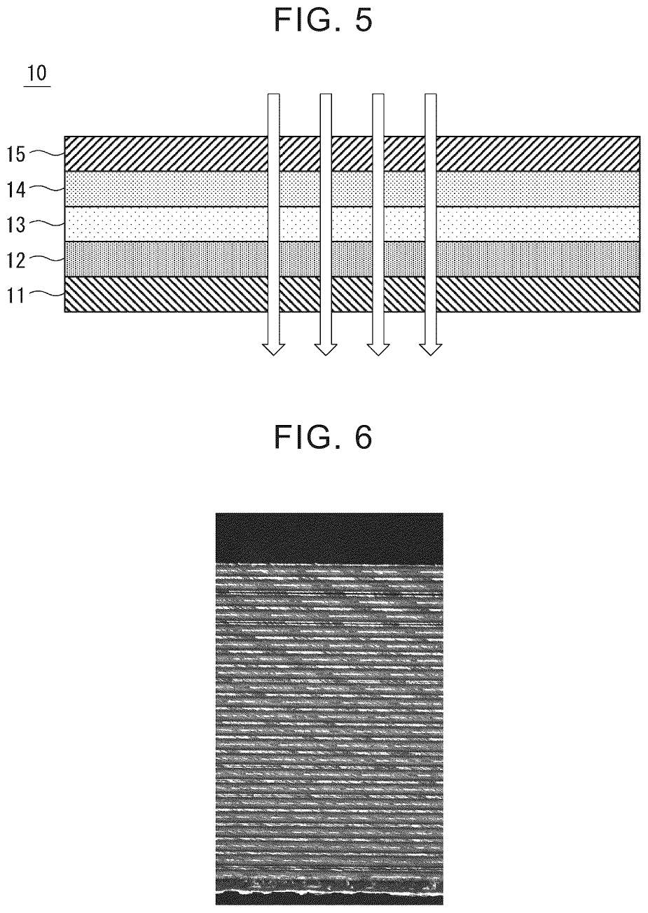

Here, FIG. 5 is a schematic cross-sectional view illustrating a state in which the side surface of the electrode stack is cut in the stacking direction of the electrode stack. FIG. 6 is a cross-sectional image showing a cut surface of an electrode stack according to the prior art in a case where the electrode stack is cut using a circular saw blade. In FIG. 6, a plurality of lines is shown in a direction that is not perpendicular to the stacking direction of the electrode stack, and the plurality of lines is marks at the time of cutting called tool marks. In FIG. 6, the distance between the lines becomes narrower toward the lower portion of the drawing, and burrs are generated at the lowermost portion.

In this regard, the inventors of the present disclosure have found that, in an electrode stack having a side surface cut in a direction that is not the stacking direction of the electrode stack, generation of burrs is suppressed, and therefore, short-circuiting between different electrodes is reduced. The reason for this is considered to be that, by cutting the side surface of the electrode stack in a direction that is not the stacking direction of the electrode stack, excessive stress is not applied in the stacking direction of the electrode stack in the cross section of the electrode stack.

In the context of the present disclosure, an “electrode stack” means a stack constituting a unit cell. Here, the “unit cell” may include a stack of a cathode current collector layer, a cathode active material layer, an electrolyte layer (separator layer), an anode active material layer, and an anode current collector layer.

In the context of the present disclosure, “the stacking direction of the electrode stack” means “the direction parallel to the stacking direction of the electrode stack”.

With regard to the present disclosure, in each layer constituting the electrode stack and the electrode stack, a wide surface constituting a wide surface that is a layered form is referred to as a “principal surface”, and a surface constituting a thickness so as to pass between the principal surfaces is referred to as a “side surface”.

In the context of the present disclosure, “cutting” means scraping the electrode stack as a workpiece with a cutter, i.e., deforming and scraping the electrode stack. On the other hand, “cutting” means dividing the electrode stack without giving any deformation. In cutting, chips are necessarily generated, whereas in cutting, they are not necessarily. Therefore, the meanings of both terms are different.

As illustrated in FIG. 1, the electrode stack 10 of the present disclosure includes a first current collector layer 11, a first electrode active material layer 12, a solid electrolyte layer 13, a second electrode active material layer 14, and a second current collector layer 15 in this order.

As long as the electrode stack has, at least in part, each layer constituting the electrode stack in the above-described order, the order in which the layers are stacked in the other portions is not particularly limited. For example, the first electrode active material layer 12, the solid electrolyte layer 13, the second electrode active material layer 14, and the second current collector layer 15 may be stacked in this order on both sides of the first 30 current collector layer 11. That is, the second current collector layer 15, the second electrode active material layer 14, the solid electrolyte layer 13, the first electrode active material layer 12, the first current collector layer 11, the first electrode active material layer 12, the solid electrolyte layer 13, the second electrode active material layer 14, and the second current collector layer 15 may be stacked in this order. In this case, the “first current collector layer” and the “first electrode active material layer” may be the “second current collector layer” and the “second electrode active material layer” and the counter electrode, respectively. That is, the “first current collector layer” and the “first electrode active material layer” may be the “cathode current collector layer” and the “cathode active material layer”, respectively. At this time, the “second current collector layer” and the “second electrode active material layer” may be the “anode current collector layer” and the “anode active material layer”, respectively. Similarly, the “first current collector layer” and the “first electrode active material layer” may be the “anode current collector layer” and the “anode active material layer”, respectively. At this time, the “second current collector layer” and the “second electrode active material layer” may be the “cathode current collector layer” and the “cathode active material layer”, respectively.

Further, for example, the first current collector layer 11, the first electrode active material layer 12, the solid electrolyte layer 13, the second electrode active material layer 14, the second current collector layer 15, the first electrode active material layer 12, the solid electrolyte layer 13, the second electrode active material layer 14, and the first current collector layer 11 may be stacked in this order. In this case, both the “first current collector layer” and the “second current collector layer” may be current collectors having the functions of both the cathode current collector and the anode current collector. The “first electrode active material layer” and the “second electrode active material layer” may be either a “cathode active material layer” or an “anode active material layer”, respectively. That is, in this case, the electrode stack 10 of the present disclosure may be a bipolar electrode.

As illustrated in FIG. 1, the electrode stack 10 of the present disclosure has a side surface cut in a direction that is not the stacking direction of the electrode stack. Such a configuration can reduce short-circuiting between different electrodes.

The shape of the cut side surface of the electrode stack is not particularly limited. For example, the side surface of the electrode stack 10 may have a corrugated shape in a direction that is not the stacking direction of the electrode stack, and in particular, as illustrated in FIG. 2, may have a corrugated shape in a direction perpendicular to the stacking direction of the electrode stack. FIG. 2 is a schematic plan view showing an example of the shape of edges of the electrode stack of the present disclosure.

On the side surface of the electrode stack, in a direction that is not the stacking direction of the electrode stack, as a method of forming the corrugated shape, using a cutting tool such as an end mill helix angle is larger than 0°, a method of side cutting (also referred to as side processing) is exemplified. In particular, on the side surface of the electrode stack, as a method of forming the corrugated shape in a direction perpendicular to the stacking direction of the electrode stack, the helix angle is 0°, using a cutting tool such as an end mill, a method of side cutting is exemplified. In the context of the present disclosure, “side cutting” means cutting the side surface of the electrode stack with a cutting tool while moving the cutting tool and/or the electrode stack such that the cutting tool and the main surface of the electrode stack as a workpiece are orthogonal. In other words, it means that the side surface of the electrode stack is cut with the cutting tool whose rotation axis is tilted by about 0° with respect to the stacking direction of the electrode stack, while moving the cutting tool and/or the electrode stack. In particular, end mills can be used for the side cutting. A method of cutting the side surface of the electrode stack will be described in detail in a method of manufacturing an electrode stack described later.

The width W of the grooves of the corrugated shape is not particularly limited. For example, a member for fixing and/or protecting the electrode stack may be disposed on the side surface of the cut electrode stack, but in such a case, the width W may be narrow from the viewpoint of facilitating fixing the member to the side surface of the electrode stack. From the viewpoint of productivity, the width W may be wide. The width W can be adjusted by the feed amount per rotation of the cutting tool, the number of blades, and the like.

Note that, in FIG. 2, a state in which a pair of opposing side surfaces of the electrode stack has a corrugated shape is illustrated, but it is sufficient that at least one side surface has a corrugated shape.

The shape of the electrode stack is not particularly limited. For example, the shape of the main surface of the electrode stack before the side surface is cut is a square, a rectangle, a diamond, a trapezoid, a parallelogram, or the like. Further, the shape of the main surface may be a polygon other than a quadrangle, or may be a shape having a curve such as a circle. Examples of the cross-sectional shape of the side surface include squares such as a square, a rectangle, a diamond, a trapezoid, and a parallelogram.

In particular, the shape of the main surface of the electrode stack before the side surface is cut may be rectangular, and the cross-sectional shape of the side surface may be rectangular. That is, the electrode stack before the side surface is cut may be a rectangular parallelepiped. In this case, the side surface formed by the long side of the electrode stack may be cut.

The size of the electrode stack is not particularly limited, and can be appropriately set in accordance with the use of the battery.

Hereinafter, each member that can constitute the electrode stack according to the present disclosure will be described.

In order to facilitate understanding of the present disclosure, each member of the electrode stack of the lithium ion secondary battery which is a solid-state battery is described as an example, but the battery of the present disclosure is not limited to the lithium ion secondary battery. In the context of the present disclosure, a “solid state battery” means a battery that uses at least a solid electrolyte as an electrolyte, and therefore a solid state battery may use a combination of a solid electrolyte and a liquid electrolyte as an electrolyte. The solid-state battery of the present disclosure may be an all-solid-state battery, that is, a battery using only a solid electrolyte as an electrolyte. cathode current collector layer

The conductive material used for the cathode current collector layer is not particularly limited, and may be, for example, SUS, aluminum, copper, nickel, iron, titanium, carbon, or the like.

The shape of the cathode current collector layer is not particularly limited, and examples thereof include a foil shape, a plate shape, and a mesh shape. Among the above, the foil shape is preferred.

The cathode current collector layer may extend from an uncut side surface of the electrode stack, and a plurality of cathode current collector layers may be collected in the extending portion.

### Cathode Active Material Layer

The cathode active material layer includes at least a cathode active material, and preferably further includes a solid electrolyte described later. In addition, an additive used in a cathode active material layer of a solid battery, such as a conductive auxiliary agent or a binder, may be included in accordance with the use purpose, the use purpose, and the like.

The material of the cathode active material is not particularly limited. For example, the positive electrode active material may be lithium cobalt oxide (LiCoO₂), lithium nickelate (LiNiO₂), lithium manganite (LiMn₂O₄), Li_{1.5}Co_{1/3}Ni_{1/3}Mn_{1/3}O₂, LiCo_{1/3}Ni_{1/3}Mn_{1/3}O₂, a heteroelement-substituted Li-Mn spinel having a composition represented by Li₁₊ₓMn_{2-x-y}M_{y}O₄ (M is at least one metal element selected from among Al, Mg, Co, Fe, Ni, and Zn), or the like.

The conductive aid is not particularly limited. For example, the conductive auxiliary agent may be a carbon material such as VGCF (Vapor Grown Carbon Fiber), carbon nanofiber, or the like, or a metallic material.

The binder is not particularly limited. For example, the binder may be a material such as polyvinylidene fluoride (PVdF), carboxymethylcellulose (CMC), butadiene rubber (BR) styrene butadiene rubber (SBR), or a combination thereof. Solid electrolyte layer

The solid electrolyte layer contains at least a solid electrolyte. The solid electrolyte is not particularly limited, and a material that can be used as a solid electrolyte of a solid battery can be used. For example, the solid electrolyte may be a sulfide solid electrolyte, an oxide solid electrolyte, a polymer electrolyte, or the like.

Examples of sulfide solid electrolytes include, but are not limited to, sulfide-based amorphous solid electrolytes, sulfide-based crystalline solid electrolytes, argyrodite-type solid electrolytes, and the like. Examples of a specific sulfide solid electrolyte include Li₂S-P₂S₅ based solid electrolytes (Li₇P₃S₁₁, Li₃PS₄, Li₈P₂S₉, etc.), Li₂S-SiS₂, LiI-Li₂S-SiS₂, LiI-Li₂S-P₂S₅, LiI-LiBr-Li₂S-P₂S₅, Li₂S-P₂S₅-GeS₂ (Li₁₃GeP₃S₁₆, Li₁₀GeP₂S₁₂, etc.), LiI-Li₂S-P₂O₅, LiI-Li₃PO₄-P₂S₅, Li₇₋ₓPS₆₋ₓClₓ, etc. or combinations thereof. Examples of specific sulfide solid electrolytes are not limited thereto.

Examples of an oxide solid electrolyte include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, Li₃₊ₓPO₄₋ₓNₓ(LiPON), etc. Examples of oxide solid electrolytes include, but are not limited to:
Polymeric electrolytes include, but are not limited to, polyethylene oxide (PEO), polypropylene oxide (PPO), and the like, and copolymers thereof.

The solid electrolyte may be glass or crystallized glass (glass-ceramic). In addition, the solid electrolyte layer may contain a conductive auxiliary agent, a binder, or the like as necessary in addition to the above-described solid electrolyte. For the conductive assistant and the binder, reference can be made to the above description of the cathode active material layer.

### Anode Active Material Layer

The anode active material layer includes at least an anode active material, and preferably further includes the above-described solid electrolyte. In addition, an additive used in an anode active material layer of a solid battery, such as a conductive auxiliary agent and a binder, may be included in accordance with the use purpose, the use purpose, and the like.

The material of the anode active material is not particularly limited, and is preferably capable of occluding and releasing metal ions such as lithium ions. For example, the anode active material may be an oxidation-based anode active material, an alloy-based anode active material, a carbon material, or the like, but is not limited thereto.

The oxidized anode active material is not particularly limited, and examples thereof include lithium titanate (LTO) grains.

The alloy-based anode active material is not particularly limited, and examples thereof include a Si alloy-based anode active material and a Sn alloy-based anode active material. Examples of Si alloy-based anode active material include silicon, silicon oxide, silicon carbide, silicon nitride, and solid solutions thereof. In addition, the Si alloy-based anode active material can contain elements other than silicon, such as Fe, Co, Sb, Bi, Pb, Ni, Cu, Zn, Ge, In, Sn, and Ti. Examples of Sn alloy-based anode active material include tin, tin oxide, tin nitride, and solid solutions thereof. In addition, the Sn alloy-based anode active material can contain elements other than tin, such as Fe, Co, Sb, Bi, Pb, Ni, Cu, Zn, Ge, In, Ti, and Si.

The carbon material is not particularly limited, and examples thereof include hard carbon, soft carbon, and graphite.

For the solid electrolyte used in the anode active material layer, reference can be made to the above description regarding the solid electrolyte layer, and for the conductive auxiliary agent and the binder, reference can be made to the above description regarding the cathode active material layer.

### Anode Current Collector Layer

The conductive material used for the anode current collector layer is not particularly limited, and may be, for example, SUS, aluminum, copper, nickel, iron, titanium, carbon, or the like, but is not limited thereto.

The shape of the anode current collector layer is not particularly limited, and examples thereof include a foil shape, a plate shape, and a mesh shape. Among the above, the foil shape is preferred.

The anode current collector layer may extend from an uncut side surface of the electrode stack, and a plurality of anode current collector layers may be collected in the extending portion.

Method for manufacturing electrode stack

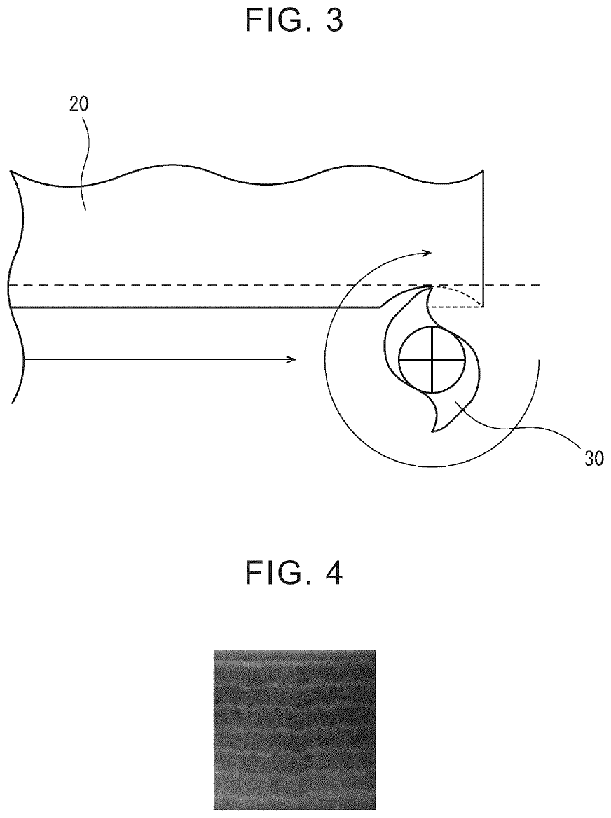

The method of the present disclosure for manufacturing the electrode stack 10 includes the following steps: (a) providing a preliminary stack 20 in which the first current collector layer 11, the first electrode active material layer 12, the solid electrolyte layer 13, the second electrode active material layer 14, and the second current collector layer 15 are stacked in this order; and (b) cutting the side surfaces of the preliminary stack in a direction that is not the stacking direction of the electrode stack, as illustrated in FIG. 3. By manufacturing the electrode stack by such a method, it is possible to reduce short-circuiting between different electrodes.

The method of the present disclosure includes (a) providing a preliminary stack 20 in which a first current collector layer 11, a first electrode active material layer 12, a solid electrolyte layer 13, a second electrode active material layer 14, and a second current collector layer 15 are stacked in this order.

The method of providing the preliminary stack is not particularly limited. For example, the preliminary stack can be provided by stacking the layers constituting the preliminary stack in a desired order. The method of stacking the layers is not particularly limited. For example, a method in which the first electrode active material layer 12, the solid electrolyte layer 13, and the second electrode active material layer 14 are formed by powder compaction, and the first current collector layer 11 and the second current collector layer 15 are stacked in a desired order. Further, there is a method in which a mixture slurry capable of forming each layer of the first electrode active material layer 12, the solid electrolyte layer 13, and the second electrode active material layer 14 is applied to a base material and then dried, and the layers are stacked in a desired order. The base material of the first electrode active material layer 12 may be, for example, the first current collector layer 11. The base material of the solid electrolyte layer 13 may be, for example, a separable metal foil such as aluminum foil. The base material of the second electrode active material layer 14 may be, for example, the second current collector layer 15.

As illustrated in FIG. 3, the method of the present disclosure includes (b) cutting the side surfaces of the preliminary stack 20 in a direction that is not the stacking direction of the electrode stack. In FIG. 3, a circular arrow indicates a rotation direction of the cutting tool 30, and a straight arrow indicates a movement direction of the preliminary stack 20. Further, the wide dashed line of the linear spacing shows the region to be cut of the electrode stack, narrow dashed line of the distance consisting of the curve and straight line shows the portion to be cut from this with the rotation of the cutting tool 30. That is, FIG. 3 is a schematic plan view showing a state in which the cutting tool 30 is rotated in a direction indicated by a circular arrow and the preliminary stack 20 is moved in a direction indicated by a straight arrow, thereby cutting the side surface.

In the step (b), the side surface of the preliminary stack may be cut with the cutting tool 30 whose rotation axis is tilted by 30° or less with respect to the stacking direction of the electrode stack. The slope may be less than or equal to 20°, less than or equal to 10°, less than or equal to 5°, less than or equal to 2°, less than or equal to 1°, or about 0°. In particular, the side surface of the preliminary stack may be cut with a cutting tool whose rotation axis is parallel to the stacking direction of the electrode stack. In the context of the present disclosure, a “parallel rotation axis” means a rotation axis tilted by about 0° with respect to the stacking direction of the electrode stack.

By the cutting tool whose rotation axis is tilted by 30° or less with respect to the stacking direction of the electrode stack, the side surface of the preliminary stack as a method of cutting the side surface of the preliminary stack is not particularly limited. For example, a method of side cutting using a cutting tool such as an end mill can be employed.

In this case, the cutting tool may have a helix angle of 30° or less, 20° or less, 10° or less, 5° or less, 2° or less, or 1° or less, and in particular, may be about 0°. The “cutting tool has a helix angle of 0°” means that the blade in the cutting tool is in a non-twisted state. By applying a cutting tool having a small helix angle to the method of the present disclosure, it is possible to suppress an excessive force from being applied to the stacking direction of the electrode stack in the cross section of the electrode stack, and thus it is possible to reduce short-circuiting between different electrodes. This effect is particularly pronounced when the cutting tool has a helix angle of 0°.

FIG. 4 is a cross-sectional image showing a cutting surface of an electrode stack of the present disclosure in a case where the side surface of the electrode stack is cut with an end mill having a helix angle of 0°. As shown in FIG. 4, when the electrode stack was cut using an end mill having a helix angle of 0°, in the cross section of the electrode stack, the tool mark was formed substantially perpendicular to the stacking direction of the electrode stack, that is, substantially parallel to the plane direction. This means that, in the cross section of the electrode stack, the force applied to the stacking direction of the electrode stack is particularly small.

When cutting an edge of the electrode stack with an end mill with a small helix angle, particularly a helix angle of 0°, scattering of chips can be reduced compared with when cutting an edge of the electrode stack with a cutting tool such as a circular saw blade or a metal saw. Therefore, there is an advantage that post-processing of chips is easy.

In the case of side cutting, the cutting method may be up-cut or down-cut. The method of cutting may in particular be a down-cut, in order to be able to finish the surface roughly and thereby easily fix a member for fixing and/or protecting the electrode stack which may be arranged on the side surface of the electrode stack described above.

Although FIG. 3 illustrates a state in which one side surface of the preliminary stack is cut, for example, a pair of opposing side surfaces may be cut at the same time.

### Battery

The battery of the present disclosure includes the electrode stack of the present disclosure and a laminate film sealing the electrode stack. Such a configuration can reduce short-circuiting between different electrodes in the electrode stack.

The battery of the present disclosure may be, for example, a lithium-ion secondary battery. Applications of batteries include, for example, power supplies for vehicles such as hybrid electric vehicle (HEV), plug-in hybrid electric vehicle (PHEV), battery electric vehicle (BEV), gasoline-powered vehicles, and diesel-powered vehicles. In particular, it is preferably used as a power supply for driving of hybrid electric vehicle (HEV), plug-in hybrid electric vehicle (PHEV), or battery electric vehicle (BEV). Also, the battery in the present disclosure may be used as a power source for mobile bodies other than vehicles (for example, railroads, ships, and aircraft), and may be used as a power source for electric products such as an information processing device.

### Electrode Stack

For the electrode stack, reference can be made to the above description of the electrode stack of the present disclosure.

### Laminate Film

The battery of the present disclosure has a laminate film. The laminate film seals the electrode stack. Specifically, the laminate film may be sealed by winding the electrode stack. In addition, the laminate film may be constituted by two films, and in this case, the two films may be used to sandwich and seal the electrode stack from above and below the electrode stack in the stacking direction.

The shape and size of the laminate film are not particularly limited as long as the electrode stack can be sealed.

The laminate film may include a sealant resin layer, a metal layer, and a protective resin layer in this order along the thickness direction. Examples of the sealant resin include olefin-based resins such as polypropylene (PP) and polyethylene (PE). Examples of the material of the metal layer include aluminum, an aluminum alloy, and stainless steel. Examples of the protective resin-layer include polyethylene terephthalate (PET) and nylon.

The thickness of each layer constituting the laminate film and the thickness of the laminate film are not particularly limited. The thickness of the sealant resin layer is, for example, 40 μm or more and 100 μm or less. The thickness of the metal layer is, for example, 30 μm or more and 60 μm or less. The thickness of the protective resin layer is, for example, 20 μm or more and 60 μm or less. The thickness of the laminate film is, for example, 80 μm or more and 250 μm or less.

### Current Collector Terminal

The battery of the present disclosure may further include a current collector terminal electrically connected to the current collector foil of the electrode stack. In this case, the laminate film may seal the electrode stack together with the current collector terminal. Specifically, in the laminate film, the electrode stack and the current collector terminal may be wound to seal the electrode stack together with the current collector terminal. In addition, the laminate film may be composed of two films, and in this case, the electrode stack may be sealed together with the current collector terminal by sandwiching the electrode stack and the current collector terminal from above and below the electrode stack in the stacking direction by the two films.

The current collector foil may extend from an uncut side of the electrode stack, so that the current collector terminal may be located on an uncut side of the electrode stack. The current collector terminal may be disposed on a pair of opposite side surfaces of the electrode stack.

The shape and size of the current collector terminal are not particularly limited as long as the electrode stack can be sealed together with the laminate film.

The material of the current collector terminal is not particularly limited as long as it has a current collector function, but may be a metal, particularly aluminum, stainless steel, or the like.

What is claimed is:

1. An electrode stack comprising a first current collector layer, a first electrode active material layer, a solid electrolyte layer, a second electrode active material layer, and a second current collector layer in this order, wherein the electrode stack includes a side surface cut in a direction that is not a stacking direction of the electrode stack.

2. The electrode stack according to claim 1, wherein the side surface has a corrugated shape in a direction perpendicular to the stacking direction of the electrode stack.

3. A method for manufacturing the electrode stack according to claim 1, the method comprising:
(a) providing a preliminary stack in which a first current collector layer, a first electrode active material layer, a solid electrolyte layer, a second electrode active material layer, and a second current collector layer are stacked in this order; and
(b) cutting a side surface of the preliminary stack in a direction that is not a stacking direction of the electrode stack.

4. The method according to claim 3, wherein, in the (b), the side surface of the preliminary stack is cut with a cutting tool whose rotation axis is tilted by 30° or less with respect to the stacking direction of the electrode stack.

5. The method according to claim 4, wherein the cutting tool has a helix angle of 0°.
